(19) United States
(12) Patent Application Publication
(10) Pub. No.: US 2002/0122445 A1
(43) Pub. Date: Sep. 5, 2002

(54) Laser with substantially uniform microwave excitation

(75) Inventors: Eli Jerby, Rishon Letzion (IL); Avi Shahadi, Ramat Gan (IL); Yoav Sintov, Petach Tikva (IL); Shaul Yatsiv, Jerusalem (IL)

Correspondence Address: DR. MARK FRIEDMAN LTD., C/O BILL POLKINGHORN - DISCOVERY DISPATCH, 9003 FLORIN WAY, UPPER MARLBORO, MD, 20772, US

(73) Assignee: RAMOT UNIVERSITY AUTHORITY FOR APPLIED RESEARCH AND INDUSTRIAL DEVELOPTMENT LTD

(21) Appl. No.: 09/761,728

(22) Filed: Jan. 18, 2001

(51) Int. Cl. H01S 3/13; H01S 3/22; H01S 3/223; H01S 3/097; H01S 3/09

(52) U.S. Cl. 372/29.023; 372/55; 372/81; 372/90

(57) ABSTRACT

A laser with microwave excitation includes a source of microwave radiation coupled to a microwave resonator. The resonator is configured such that the microwave radiation generates an oscillating electric-field perpendicular to the longitudinal axis of the resonator corresponding to the first longitudinal resonator mode standing wave pattern. An excitation cavity, housing at least one gas discharge conduit, is coupled to the microwave resonator along a major portion of the cavity's length. The excitation cavity is configured to be below cutoff.

### FIELD AND BACKGROUND OF THE INVENTION

The present invention relates to lasers and, in particular, it concerns gas discharge lasers which employ microwave excitation.

Since the invention of gas discharge lasers, various excitation methods have been used. The most obvious and easiest method was the direct current, or DC discharge which used metal electrodes enclosed in a gas tight vessel that was in direct contact with the laser gas. However, this technique had the drawback of requiring very high voltages with lengthy laser tubes. Interactions between the electrodes and the gas also tended to reduce the lifetime of the scaled laser tubes.

To overcome the DC excitation method limitations radio frequency, or RF power has been utilized to breakdown and excite the laser gas, otherwise known as gas discharge.

Early gas lasers used RF excitation by coupling an oscillating electromagnetic field, either capacitively or inductively, through the insulating walls of a gas tight vessel. However, the use of RF power requires an expensive power source since a DC power supply, an RF amplifier, and the associated components are required.

A more economical means for excitation utilizes microwave energy. The short wavelengths associated with electromagnetic excitation energy require that it is confined in an enclosed metal structure to prevent the loss of microwave power by radiation to the environment. The best design for the enclosed metal structure is to make the structure resonant at the microwave operating frequency, so as to produce an intense discharge in the laser gas with less microwave power loss in the metal walls of the enclosure.

A structure of this type is known as a microwave resonant cavity, or a waveguide with end walls. A waveguide with end walls is a microwave resonant cavity when the end walls are spaced an integer multiple of one-half waveguide wavelengths apart. Such resonant cavities, or waveguides have fixed standing wave patterns that are determined by the dimensions of the cavity and the wavelength of the microwaves.

Standing wave patterns in microwave cavities or waveguides always have zero electric field strength at the walls of the waveguide since the walls short circuit the electric field. The electric field increases from zero at locations away from the walls. However, if the cavity is large enough, the electric field will decrease to zero at points that are approximately one-half the resonator- wavelength away from the cavity wall. A sanding wave pattern in a large waveguide would have many locations where the electric field strength would always be zero, and as a result, no gas discharge could exist at those locations.

Therefore, microwave excitation is inherently non-uniform since where the electric field is strongest, the gas would be over pumped, and one-quarter wavelength away the gas would not be pumped at all. This characteristic is particularly inefficient for pumped level dependant lasers, such as carbon dioxide (CO₂) lasers.

Large scale mass production of magnetrons for commercial microwave ovens has reduced the cost of magnetrons to be significantly less than the cost of an average RF power source of equal power.

One of the main difficulties of utilizing the lower cost magnetron power supply is creating gas discharge uniformity, which is critical because localized over pumping and heating of the laser gas produces regions with negative gain, which reduces or destroys laser performance.

CO₂ gas lasers have an optimum level of pumping and an efficient CO₂ laser will achieve the optimum pump level along the entire gain length of the laser. The prior art microwave lasers do not achieve an efficient discharge uniformity and call only operate as fast flowing gas lasers, where the gas flows through the optical cavity so that the gas is not over heated.

Other prior art microwave lasers rely on pulsed microwave discharges with short pulse durations to avoid localized over heating of thee laser gas, yet the discharge is non-uniform and inefficient.

Prior U.S. Patents have addressed the issue of utilizing magnetrons as a laser power source and the inherent problems with using microwave power.

For example, U.S. Pat. No. 5,79,317 issued to Bridges et al. utilizes a microwave excited slab waveguide laser to take advantage of mass produced magnetrons and to reduce the cost of the microwave excited laser.

U.S. Pat. No. 4,926,434 issued to Ross discloses a short circuit element and an igniter for a microwave excited laser. However, this particular design maximizes the electric field strength at the far end of the waveguide, which would produce a nob-uniform gas discharge.

U.S. Pat. No. 5,347,530 issued to Gekart et al. utilizes a short circuit plate with a ring electrode to terminate the main waveguide and discharge tube assembly. However, this design will result in an electric field having zero strength, or a standing wave, at the short circuit plate, and therefore, no discharge will occur at that area.

U.S. Pat. No. 4,780,881 issued to Zhang et al. discloses a laser utilizing a metallic short circuit and an igniter as a way of starting and maintaining a discharge in the laser.

U.S. Pat. No. 4,217,560 issued to Kosyrev et al discloses an adjusting screw in direct contact with an electrode to compensate for changes in the electric characteristics of the laser.

U.S. Pat. No. 4,759,029 issued to Siemens attempts to address the issue of gas discharge non-uniformity by using a large number of discrete adjustable electrodes; however, due to the configuration of the waveguides, which are terminated by open circuits, the laser will have a standing wave pattern with regions of low energy transfer and corresponding dark spots in the gasp discharge volume.

Furthermore, U.S. Pat. No. 4,759,029 has practical limitations because the discrete electrodes have a plurality of sharp edges. The discrete sharp edges of this disclosure promote microwave arcing in the air volume internal of the cavity, which creates an unreliable and inefficient laser operation. The discrete nature of the electrodes create gas discharge non-uniformity. The use of a large number of electrodes is also not economical and is impractical due to the large number of individual adjustments that would be required to tune the laser while attempting a uniform gas discharge.

U.S. Pat. No. 5,684,821 issued to Murray et al. describes a further attempt to address the issue of gas discharge non-uniformity by using a waveguide of variable dimensions. This approach, however, is highly complex to implement, requiring numerous adjustments to properly approximate to a uniform field. Achieving a uniform field in such a manner does not insure an efficient matching of the laser plasma to the source. The consequent coupling power losses result in loss of efficiency. Finally with respect to Murray et al, the use of a cylindrical gas discharge tube greatly limits the output power per unit length which can be generated by the laser.

There is therefore a need for a laser with microwave excitation which would provide substantially uniform excitation along the length of a gas discharge tube with greater efficiency than is offered by existing devices.

### SUMMARY OF THE INVENTION

The present invention is a laser with substantially uniform microwave excitation.

According to the teachings of the present invention there is provided, a laser with microwave excitation comprising; (a) a source of microwave radiation of at least one given wavelength; (b) a microwave resonator coupled to the source of microwave radiation, the resonator having a first length L₁ measured along a first longitudinal axis and being configured such that the microwave radiation generates within the resonator oscillating fields perpendicular to the longitudinal axis corresponding substantially to a first longitudinal mode; and (c) an excitation cavity having a second length L₂ measured along a second longitudinal axis parallel to the first longitudinal axis, the excitation cavity being coupled to the microwave resonator along a major portion of the second length, at least one gas discharge conduit being deployed at least partially within the excitation cavity, so as to extend substantially -parallel to the second length, wherein the excitation cavity is configured to be below cutoff.

According to a further feature of the present invention, second length L₂ is less than first length L₁.

According to a further feature of tie present invention, the resonator is configured to allow propagation exclusively of a first longitudinal TE resonator mode.

According to a further feature of the present invention, the internal shape and dimensions of a cross-section taken through the resonator perpendicular to the first longitudinal axis is substantially constant along the first length.

According to a further feature of the present invention, the source of microwave radiation includes a magnetron microwave generator.

According to a further feature of the present invention, the gas discharge conduit is implemented with a substantially rectangular cross-section and the excitation cavity is implemented as a waveguide having a pair of inwardly projecting ridges extending parallel to the second longitudinal axis, the gas discharge conduit being mounted between the pair of ridges.

According to a further feature of the present invention, coupling between the resonator and the excitation cavity occurs via an elongated slot opening therebetween, the slot extending along substantially the entirety of second length L₂. A plurality of adjustable tuning elements are preferably deployed adjacent to the elongated slot so as to allow adjustment of the coupling between the resonator and the excitation cavity along the elongated slot.

### BRIEF DESCRIPTION OF THE DRAWINGS

The invention is herein described, by way of example only, with reference to the accompanying drawings, wherein:

FIG. 1 is a schematic isometric view of a laser, constructed and operative according to the teachings of the present invention, with microwave excitation;

FIG. 2 is a schematic plan view of a microwave resonator and an excitation cavity from the laser of FIG. 1;

FIG. 3 is a graph illustrating a peak electric field amplitude within the microwave resonator of FIG. 1 as a function of position along a longitudinal axis;

FIG. 4 is a schematic cross-sectional view taken through a preferred implementation of the excitation cavity of FIG. 1; and

FIG. 5 is a schematic partial cross-sectional view illustrating coupling of a magnetron microwave source to the resonator of FIG. 1.

### DESCRIPTION OF THE PREFERRED EMBODIMENTS

The present invention is a laser with substantially uniform microwave excitation.

The principles and operation of a laser according to the present invention may be better understood with reference to the drawings and the accompanying description

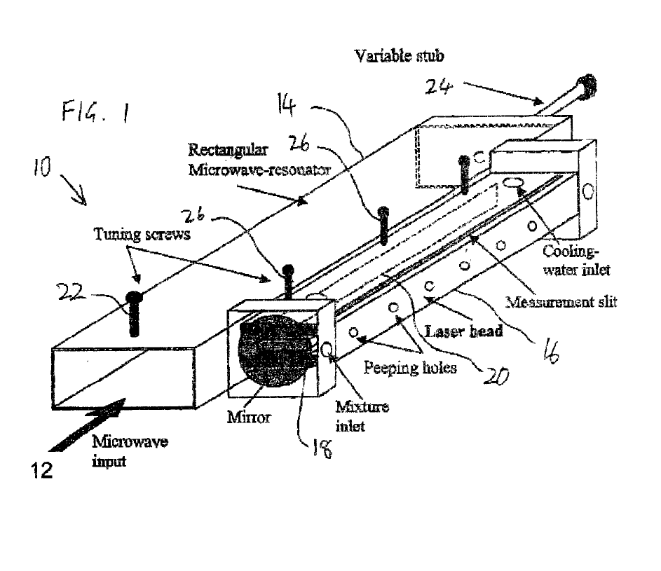

Referring now to the drawings, FIG. 1 shows a preferred implementation of a laser, generally designated 10, constructed and operative according to the teachings of the present invention, which employs microwave excitation.

Generally speaking, laser 10 includes a source of microwave radiation 12 coupled to a microwave resonator 14. Resonator 14 of length L₁, is configured such that the microwave radiation generates an oscillating electric field perpendicular to the longitudinal axis of resonator 14 corresponding substantially to a zero-order standing wave pattern. An excitation cavity 16 of length L₂ is coupled to resonator 14 along a major portion of length L₂. At least one gas discharge conduit 18 is deployed at least partially within excitation cavity 16, extending substantially parallel to its length. Excitation cavity 16 is configured to be below cutoff.

At this stages it will be appreciated that the two cavity structure of the present invention provides a number of major advantages over existing approaches to microwave excitation of gas discharge for lasers. Specifically resonator 14, which is preferably of constant cross-sectional shape and dimensions along its length, may be simply and efficiently matched to the microwave source so as to provide a substantially symmetrical field distribution along its length with minimal losses. The transverse coupling to excitation cavity 16 which is below cut-off ensures substantially uniform excitation of gas within conduit 18 without significantly affecting the field distribution within resonator 14. The result is a simple structure which provides better matching and higher overall efficiency than can be achieved by the existing techniques described above These and other advantages of the present invention will be better understood in light of the following detailed description.

Turning now to the features of the present invention in more detail, coupling between resonator 14 and excitation cavity 16 preferably occurs via an elongated slot 20 opening between them. Slot 20 preferably extends along substantially the entire length L₂ of excitation cavity 16. The length L₂ of excitation cavity 16 is preferably less than the length L₁ of resonator—, as shown in FIG. 2.

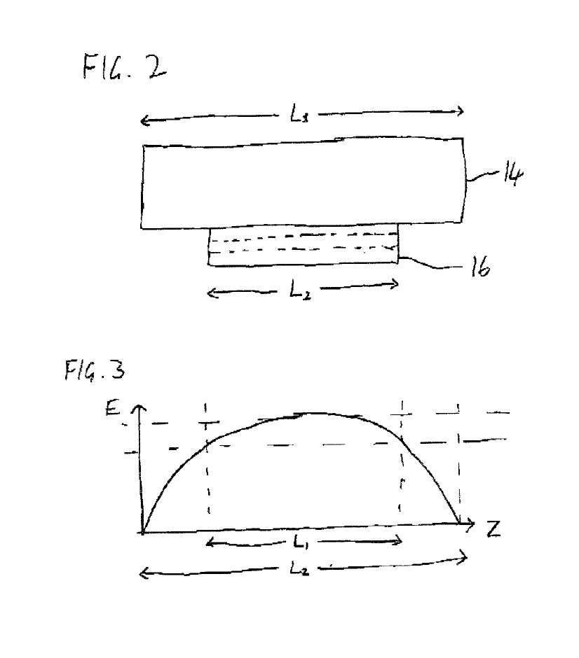

The significance of the relative lengths of resonator 14 and excitation cavity 16 will be better understood with reference to FIG. 3. Specifically, resonator 14 is preferably configured to allow propagation exclusively of a first longitudinal resonator mode. The peak transverse electric field amplitude for such a mode is shown in FIG. 3, For example: the use of the lowest TE mode (TE₁₀₁) ensures that there is no zero amplitude region along the length of resonator 14. The ends of the resonator, however, are inherently zero amplitude nodes. By choosing the length L₂ of excitation cavity 16 to be less than the length L₁ of resonator 14, and coupling excitation cavity 16 to resonator14 in its middle portion, these end portions are avoided. As a result, the power delivered to a gas in gas discharge conduit 18 inherently provides a reasonable approximation to a uniform distribution.

Preferably, one or more tuning mechanism is provided to further enhance matching of the various components and/or to improve the uniformity of excitation along the gas discharge conduit. In the preferred example of FIG. 1, adjustments for matching of resonator 14 to the microwave input include a tuning screw 22 and a variable stub 24. Adjustment of coupling between resonator 14 and excitation cavity 16 along elongated slot 20 is preferably facilitated by a plurality of adjustable tuning elements 26 deployed adjacent to, and spaced along, slot 20. Tuning adjustment may be performed using visual techniques. i.e., to achieve a uniform axial glow, and/or by measurement of the reflected measured microwave-power. For manufacturing purposes, once properly set for a given design, the states of tuning elements 26 are generally regarded as fixed standardized parameters for that design. The peep holes and measurement slit illustrated here are for setup and testing purposes and are also generally omitted once details of a given design are finalized.

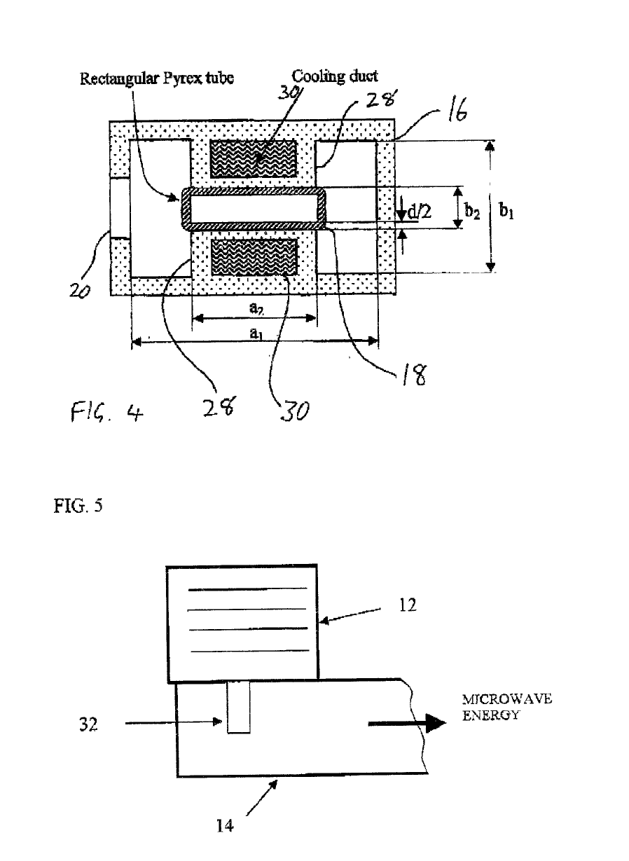

Turning now to FIG. 4, this shows a preferred structure for excitation cavity 16 wherein gas discharge conduit 18 is implemented with a substantially rectangular cross-section of a type known in the art as a “slab” structure. This slab conduit is preferably supported between a pair of inwardly projecting ridges 28 extending parallel to the longitudinal axis of excitation cavity 16. Each of the ridges preferably includes as least one cooling duct 30 configured to allow passage of a cooling fluid along the ridge. This structure is highly advantageous for providing effective cooling, thereby allowing higher output power per unit length than could be achieved with a cylindrical discharge tube.

Also shown in FIG. 4 are a number of parameters which are used to define the conditions for excitation cavity to be below cutoff. Specifically, the cutoff wavelength for a double-ridged waveguide is

$${λ}_{c} = 2 ( {a}_{1} - {a}_{2} ) {\{ \begin{matrix}1 + [ ( 2.45 + \frac{{a}_{2}}{{a}_{1}} ) {ϵ}_{r} {a}_{2} \frac{{b}_{1}}{( d + {ϵ}_{r} ( {b}_{2} - d ) ) ( {a}_{1} - {a}_{2} )} ] + \\ \frac{4 {ϵ}_{r} {b}_{2}}{π ( d + {ϵ}_{r} ( {b}_{2} - d ) )} [ 1 + \frac{1}{5} \sqrt{\frac{{b}_{1}}{{a}_{1} - {a}_{2}}} ] \frac{{b}_{1}}{{a}_{1} - {a}_{2}} ln ( \frac{1}{sin ( π {b}_{2} / 2 {b}_{1} )} )\end{matrix} \}}^{\frac{1}{2}}$$

where a₁ and a₂ are the waveguide and ridges widths respectively, b₁ and b₂ are the waveguide height and the ridges' spacing, respectively, and ε₁, and , d₂ are the relative dielectric constant and wall thickness of a rectangular Pyrex tube confining the gas.

It should be noted that the present invention is not limited to any particular type of microwave source. Examples of suitable microwave sources include, but are not limited to, magnetrons, klystron, solid-state transistors, and diode oscillators. As mentioned earlier, the present invention is highly suited for use with a magnetron microwave generator. This is particularly advantageous due to the low cost and ready availability of mass-produced magnetron microwave generators capable of good performance for pulsed operation.

Finally, with brief reference to FIG. 5, this illustrates a particularly straight forward option for coupling of a magnetron source 12 to resonator 14 employing direct coupling of the magnetron antenna 32 to the resonator. Alternatively, coupling may be performed via a coax-to-waveguide connector (not shown).

It will be appreciated that the above descriptions, are intended only to serve as examples, and that many other embodiments are possible within the spirit and the scope of the present invention.

What is claimed is:

1. A laser with microwave excitation comprising:
(a) a source of microwave radiation of at least one given wavelength
(b) a microwave resonator coupled to said source of microwave radiation, said resonator having a first length L₁ measured along a first longitudinal axis and being configured such that said microwave radiation generates within said resonator oscillating fields perpendicular to said longitudinal axis corresponding substantially to a first longitudinal mode; and
(c) an excitation cavity having a second length L₂, measured along a second longitudinal axis parallel to said first longitudinal axis, said excitation cavity being coupled to said microwave resonator along a major portion of said second length, at least one gas discharge conduit being deployed at least partially within said excitation cavity so as to extend substantially parallel to said second length, wherein said excitation cavity is configured to be below cutoff.

2. The laser of claim 1, wherein second length L₂ is less than first length L₁.

3. The laser of claim 1, wherein said resonator is configured to allow propagation exclusively of a first longitudinal TE resonator mode,

4. The laser of claim 1, wherein the internal shape and dimensions of a cross-section taken through said resonator perpendicular to said first longitudinal axis is substantially constant along said first length.

5. The laser of claim 1, wherein said source of microwave radiation includes a magnetron microwave generator.

6. The laser of claim 5, wherein said magnetron microwave generator includes an antenna, said antenna being coupled to said resonator.

7. The laser of claim 1, wherein said gas discharge conduit is implemented with a substantially rectangular cross-section.

8. The laser of claim 7, wherein said excitation cavity is implemented as a waveguide having a pair of inwardly projecting ridges extending parallel to said second longitudinal axis, said gas discharge conduit being mounted between said pair of ridges.

9. The laser of claim 8, wherein each of said ridges includes at least one cooling duct configured to allow passage of a cooling fluid along said ridge.

10. The laser of claim 1, wherein coupling between said resonator and said excitation cavity occurs via an elongated slot opening therebetween said slot extending along substantially the entirety of second length L₂

11. The laser of claim 10, further comprising a plurality of adjustable tuning elements deployed adjacent to said elongated slot so as to allow adjustment of the coupling between said resonator and said excitation cavity along said elongated slot.
